(19) United States
(12) Patent Application Publication
(10) Pub. No.: US 2018/0190220 A1
(43) Pub. Date: Jul. 5, 2018

(54) Data Pattern-Based Charge Sharing for Display Panel Systems

(71) Applicant: Parade Technologies, Ltd., Santa Clara, CA (US)

(72) Inventors: Quan Yu, Shanghai City (CN); Ta-tao Hsu, Zhubei City (TW); Yueh-lin Yang, Zhubei City (TW); Haijun Chen, Shanghai City (CN); Kuo-cheng Huang, Taipei City (TW); Nelson Rao, Hsinchu City (TW)

(21) Appl. No.: 15/904,212

(22) Filed: Feb. 23, 2018

Related U.S. Application Data
(63) Continuation of application No. PCT/US16/48752, filed on Aug. 25, 2016.
(60) Provisional application No. 62/210,386, filed on Aug. 26, 2015.

(51) Int. Cl. G09G 3/36

(52) U.S. Cl. CPC G09G 3/3614; G09G 2310/08; G09G 2330/021; G09G 3/3685

(57) ABSTRACT

A method including receiving a first row of display data for a first time period, and determining a value of a specified bit position for first portions of a first plurality of multi-bit portions in the first row. The method further includes receiving a second row of display data for a second time period, and determining a value of the specified bit position for second portions of a second plurality of multi-bit portions in the second row. Based on the determining, identifying second portions that indicate a change in the value of the specified bit position from the first time period to the second time period, and identifying an output channel associated with each identified portion. The method further includes grouping each identified output channel into a first or second group based on a polarity type, and connecting the identified output channels together within each group.

### RELATED APPLICATIONS

This application is a continuation application of PCT Patent Application No. PCT/US16/48752, entitled “Data Pattern-Based Charge Sharing for Display Panel Systems” filed on Aug. 25, 2016, which claims priority to U.S. Provisional Patent Application 62/210,386, filed on Aug. 26, 2015, each of which is incorporated herein by reference in its entirety.

### TECHNICAL FIELD

The disclosure generally relates to reducing power consumption of source drivers for a display device.

### BACKGROUND

In many electronic devices, the display panel and associated drive circuitry consume a large portion of the dynamic power consumed by the electronic device. Conventional techniques to reduce dynamic power consumption for these devices include one or a combination of reducing the bias current applied to the drive circuitry, reducing the display supply voltage, or reducing the number of data lines that provide display information. These conventional power reduction techniques, however, often negatively impact performance and may not be suitable for some display applications.

### SUMMARY

Various embodiments provide systems and methods for employing techniques to redistribute energy stored in the columns of a display panel. An example method includes receiving a first row of display data for a first time period, the first row of display data including a first plurality of multi-bit portions, wherein each multi-bit portion in the first plurality is associated with a separate output channel of a plurality of output channels included in a display panel and determining a value of a specified bit position for one or more first portions of the first plurality of multi-bit portions in the first row. The method further includes receiving a second row of display data for a second time period, the second row of display data including a second plurality of multi-bit portions, wherein each multi-bit portion in the second plurality is associated with a separate output channel of the plurality of output channels included in the display panel and determining a value of the specified bit position for one or more second portions of the second plurality of multi-bit portions in the second row, wherein the one or more second portions correspond to the one or more first portions. Based on the determined values in the first and second rows, the method further includes identifying one or more of the second portions that indicate a change in the value of the specified bit position from the first time period to the second time period. The method further includes identifying an output channel from the plurality of output channels associated with each identified portion of the second row, grouping each identified output channel into a first group or a second group based on a polarity type of the identified output channel, and connecting the identified output channels together within each group.

In some embodiments, the first time period is a write cycle for the first row of display data and the second time period is a write cycle for the second row of display data.

In some embodiments, the specified bit position is the most significant bit.

In some embodiments, the first group of identified output channels includes even numbered output channels and the second group of identified output channels includes odd numbered output channels.

In some embodiments, the first group of identified output channels includes odd numbered output channels and the second group of identified output channels includes even numbered output channels.

In some embodiments, connecting the identified output channels together within each group includes connecting the outputs of source drivers coupled to the identified output channels together within the group, responsive to receiving one or more charge sharing enable signals.

In some embodiments, the method further includes connecting the identified output channels together within each group during a polarity period. In some embodiments, the polarity period corresponds to a time period during which a polarity inversion signal remains in the same polarity state.

In yet another instance, a device is provided. The device includes a display data receiver configured to: (i) receive a first row of display data for a first time period, the first row of display data including a first plurality of multi-bit portions, wherein each multi-bit portion in the first plurality is associated with a separate output channel of a plurality of output channels included in a display panel, and (ii) receive a second row of display data for a second time period, the second row of display data including a second plurality of multi-bit portions, wherein each multi-bit portion in the second plurality is associated with a separate output channel of the plurality of output channels included in the display panel. The device further includes a display data analysis module configured to: (i) determine a value of a specified bit position for one or more first portions of the first plurality of multi-bit portions in the first row and (ii) determine a value of the specified bit position for one or more second portions of the second plurality of multi-bit portions in the second row, wherein the one or more second portions correspond to the one or more first portions. The display data analysis module is further configured to, based on the determined values in the first and second rows, identify one or more of the second portions that indicate a change in the value of the specified bit position from the first time period to the second time period and identify an output channel from the plurality of output channels associated with each identified portion of the second row. The device further includes a charge sharing controller configured to group each identified output channel into a first group or a second group based on a polarity type of the identified output channel, and connect the identified output channels together within each group.

### BRIEF DESCRIPTION OF DRAWINGS

The disclosed embodiments have other advantages and features which will be more readily apparent from the detailed description and the accompanying figures (or drawings). A brief introduction of the figures is below.

FIG. 1 is a block diagram illustrating a display panel subsystem including a timing controller and source drivers in accordance with some embodiments.

FIG. 2 is a detailed view of the timing controller of the display subsystem in accordance with some embodiments.

FIG. 3 is a detailed view of a source driver of the display subsystem in accordance with some embodiments.

FIG. 4 shows a table that illustrates data pattern-based charge sharing for output channels of a display panel subsystem of FIG. 1 in accordance with some embodiments.

FIG. 5 provides a detailed view of the display panel subsystem of FIG. 1 in accordance with some embodiments.

FIG. 6 provides a circuit diagram of display data pattern detection circuitry for an output channel of the display panel subsystem of FIG. 1 in accordance with some embodiments.

FIG. 7 provides a flow chart describing a method of performing display data-pattern based charge sharing in accordance with some embodiments.

### DETAILED DESCRIPTION

The figures and the following description relate to embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Overview—Data-Pattern Based Charge Sharing

Various embodiments provide systems and methods for employing techniques to redistribute energy stored in the columns of a display panel. The disclosed display panel system employs a display data-dependent charge sharing techniques during the same polarity period to reduce dynamic power dissipation in the display panel system. In particular, for each multi-bit display data value, the timing controller compares the value of a specified bit of a multi-bit value at first time period to the value of the same bit during a second time period. In one implementation, the specified bit is the most significant bit. The timing controller determines which channels to select for charge sharing by identifying each channel in which the value of the specified bit changed from the first time period to the second time period. The timing controller groups each identified output channel into one of two groups based on a polarity type of the identified output channel. When the timing controller initiates charge sharing during the same polarity period, the timing controller connects identified output channels that share the same polarity together. Accordingly, within the group of output channels, the charge from output channels whose output value transitions from a logic “high” value to a logic “low” value (i.e., high-to-low) is used to charge output channels whose output value transitions from a logic low to a logic high (i.e., low-to-high).

### Display Panel Subsystem

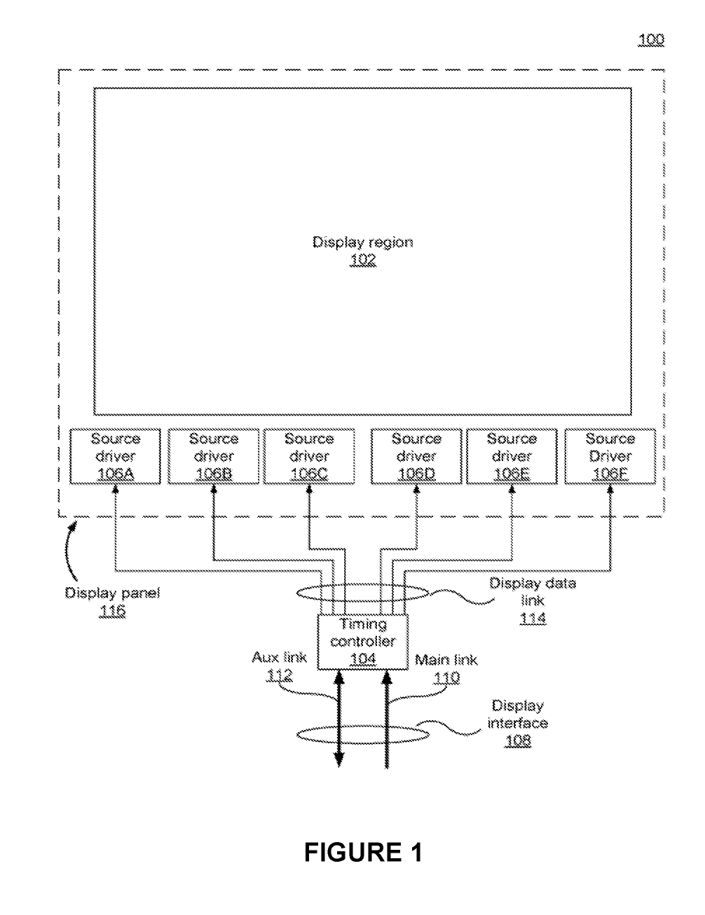

FIG. 1 illustrates a display panel subsystem 100 including a display panel 116, timing controller (TCON) 104, and source drivers 106. In the embodiment shown in FIG. 1, the display panel 116 includes one or more display regions 102 and multiple source drivers 106A, 106B, 106C, 106D, 106E, and 106F. The display region 102 includes an array of pixels arranged in multiple columns and rows. In the embodiment shown in FIG. 1, the display region 102 is embodied as a liquid crystal display (LCD), such as a thin film transistor (TFT) LCD. The display region 102 uses a TFT or other active device type to control the operation of each pixel in accordance with display data and control information received from the timing controller 104. A pixel comprises sub-pixels associated with a different color (e.g., red, green, or blue). Each sub pixel includes a storage element, such as a capacitor, to store energy delivered by the voltage signals generated by a source driver 106. Energy stored in the storage device produces a voltage used to regulate the operation of the corresponding active device for each sub-pixel. The intersection of each row and column line provides an addressable location to control to operation of a sub-pixel placed at the intersection based on control information received from the timing controller 104.

The timing controller 104 receives display data from a source over display interface 108 and generates control and data signals to selectively apply display data to certain sub-pixels included in the display region 102. Example display data sources include integrated circuits, such as a graphics processor unit (GPU) located within the same system that includes the display panel subsystem 100. Additional example display data sources include external computing system, such as a set-top box, digital video disk player, or other computing device that generates display data.

The display interface 108 is a video interface that couples the output of the display data source to the input of the timing controller 104. The display interface 108 may include an interface that conforms to specified physical, signaling, and protocol parameters suitable to transmit display data to the timing controller 104. In one implementation, the display interface 108 conforms to the DisplayPort family of video interface standards. In the embodiment shown in FIG. 1, the display interface 108 is a DisplayPort video interface that includes a main link 110 and an auxiliary link 112. The main link 110 is comprised of one or more differential signal lanes that carry video and/or audio data from the source to the timing controller 104. The auxiliary link 112 is a bi-directional differential signal channel that exchanges channel management information between the source and the timing controller 104. Example channel management information includes training information, test and debug information, and channel or device status information. The display interface 108 shown in FIG. 1 may also conform to other versions of the DisplayPort video interface standard, such as Embedded DisplayPort, or other video interface standards.

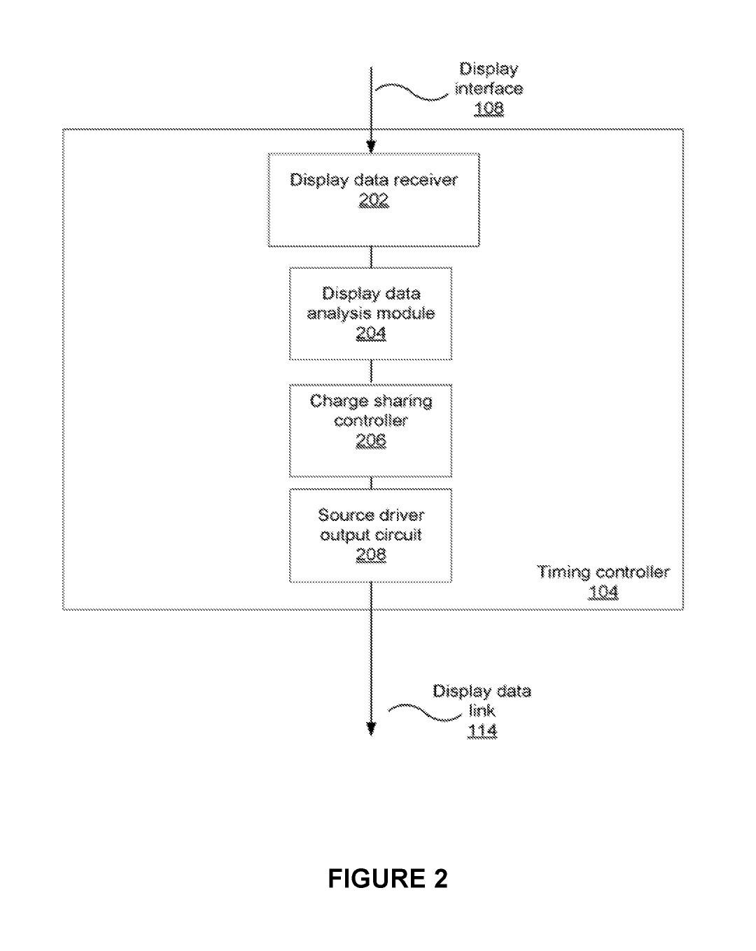

The timing controller 104 processes the display data received from the source and generates display panel interface signals for driving the source drivers 106 included in the display panel 116, as further described in FIG. 2. The timing controller 104 receives display and control data from the display interface 108 and generates control and data signals to cause the display data to be displayed on the display panel 116. In one implementation, the timing controller 104 stores the received display data in an image buffer. The image buffer may be embodied as a memory device or an embedded memory. To individually address each display segment, the timing controller 104 applies control and data signals to a specified row driver and source driver 106 to enable or disable the sub-pixel located at the intersection of the specified row and column. In one implementation, each sub-pixel within a column of pixels included in the display panel 116 is connected to a source driver 106 via one or more data bus lines. The magnitude of the voltage of the display data signal carried by the one or more data bus lines determines the amount of light transmission supplied by each corresponding sub-pixel located in the display panel 116. The timing controller 104 interfaces with the display panel 116 using a display data link 114. The display data link 114 includes multiple point-to-point interconnects that couple the output of the timing controller 104 to each source driver 106. In the embodiment shown in FIG. 1, the display data link 114 is a point-to-point intra panel interface that conforms to the Scalable Intra Panel Interface (SIPI) standard.

The source driver 106 receives multi-bit digital display data from the timing controller 104 via a signal line included in the display data link 114, converts the display data to analog voltage signals, and sends the analog voltage signals to a specified column of sub-pixels using the column line. The number of data bits used to represent a display data value determines the number of light levels that a particular sub-pixel may produce. For example, 10-bit display data may be converted into 1024 analog signal levels generated by the output buffers included a source driver 106. A measure of the intensity of the light emitted by each sub-pixel may be represented as a gray level. In one implementation, the gray level is represented by a multi-bit value ranging from 0, corresponding to black, to a maximum value. In one example, a gray level is a 10-bit value representing one of 1024 values, with a maximum value of 1023.

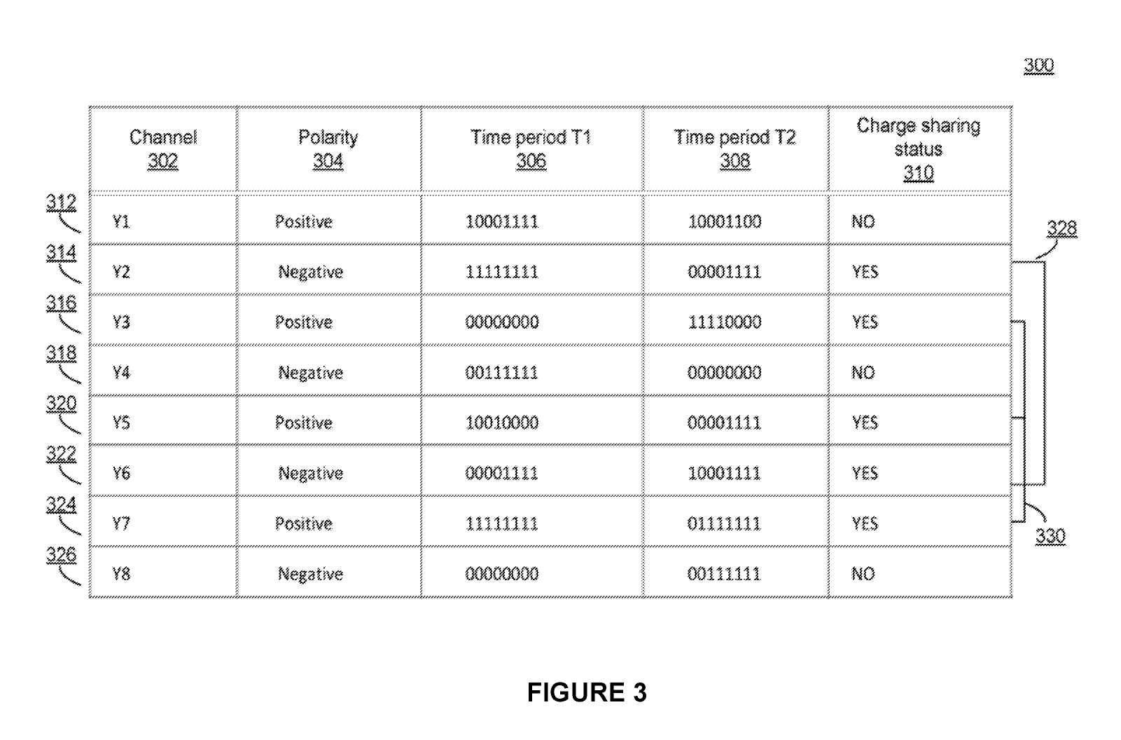

The transmission path includes the output of each source driver 106 to the input of each sub-pixel in a specific column of sub-pixels is referred to herein as an output channel. A source driver 106 includes multiple output buffers, where each output buffer operates to rapidly charge the column line of the corresponding channel. In operation, the DC power supplied to each output buffer and the dynamic power expended to charge and discharge these highly capacitive output channels dominate the overall power consumption of the display panel subsystem 100. Further description of the output buffers is provided with reference to FIG. 3.

### Timing Controller Architecture

FIG. 2 illustrates a block diagram of the timing controller 104 in greater detail in accordance with on embodiments. The timing controller 104 includes a display data receiver 202, a display data analyzer 204, a charge sharing controller 206, and source driver output circuit 208. The display data receiver 202 receives display data over the display interface 108 and generates control and data signals for displaying the display data in a display region 102 of the display panel 116. The display data represents the image to be displayed in the display region 102, and the control data determines how the display data is displayed in the display region 102.

The control data signals include global timing signals, such as vertical timing signals and horizontal timing signals. Vertical timing signals include vertical sync (VSYNC) or frame pulse (FP), and horizontal timing signals include horizontal sync (HSYNC) or line pulse (LP). The global timing signals also include display refresh signals for refreshing a displayed image, clock signals for operating row drivers, along with clock signals and latch enable signals for operating source drivers 106. Using the global timing signals, the display data receiver 202 generates control signals to map display data to a specific group of sub-pixels in the display region 102. In particular, the display data receiver 202 uses the global timing signals to send signals to row drivers and source drivers 106 to drive display data onto a specified group of sub-pixels in the display region 102. The display data receiver 202 also uses the received global timing signals to generate control signals to refresh a frame of display data.

The display data receiver 202 is also configured to perform signal conditioning on the received data to adjust or modify one or more attributes of the received data for processing by other components of the timing controller 104. For example, the display data receiver 202 extracts timing information associated with display data or control data to use in conjunction with control circuitry (e.g., shift registers, input registers, data latches, etc.) to condition display data for output by the source drivers 106. Alternatively or additionally, the display data receiver 202 descrambles the received data, decrypts encrypted data, or adjusts the voltage, timing, or other characteristics of the received data for further processing by the display data analyzer 204 or charge sharing controller 206.

The display data analyzer 204 identifies attributes of the display data received by the display data receiver 202, and generates one or more data and control signals for displaying the received display data on the display region 102. Attributes of the received display data include data structure (e.g., a row of display data or a frame of display data) and signal type (e.g., display data, control data, or link status data). The display data analyzer 204 also derives other attributes of the received display data from signals provided by the display data receiver 202. For example, in one implementation, the display data analyzer 204 uses global timing and display data signals received over the display interface 108 to calculate a frame rate and a refresh rate for the incoming display data. The frame rate represents how often a display data source can feed an entire frame of new data to a display (e.g., display panel 116). The refresh rate represents the number of times per second in which the display panel 116 presents the display data provided by the source drivers 106.

The display data analyzer 204 also determines or derives additional control information using data received over display interface 108. Example additional control information includes mapping information describing the mapping of row data and column data to specified row drivers and source drivers 106, and polarity configuration information specifying the polarity state and a polarity inversion operation mode of the display data signals output by the source driver 106. The polarity inversion operation modes include, frame polarity inversion, row polarity inversion, or column polarity inversion operation mode. Using the configuration information, the display data analyzer 204 generates one or more polarity control signals for setting the polarity of display data signals output by the source drivers 106 in accordance with a specified polarity inversion operation mode.

To prevent permanent damage to the display elements within the display panel 116, the timing controller 104 alternates or inverts the polarity of display data signals supplied to each the sub-pixel between successive sequential video frames. During a polarity inversion period, the timing controller 104 supplies a polarity inversion signal to one or more source drivers 106 in accordance with a specified polarity inversion operation mode. Responsive to the polarity inversion signal, each source driver 106 outputs display data signals with alternate positive and negative polarity between the sub-pixels with respect to a backside electrode in accordance with the specified inversion operation mode.

The timing controller 104 is configured to implement any one or a combination of different inversion operation modes. For example, in frame inversion operation mode, all display elements in the display panel are driven with the same polarity display data signal during even numbered (even) frames and the opposite polarity display data signal during odd numbered (odd) frames. In column inversion operation mode, display elements in adjacent columns are driven with opposite polarity display data signals and change polarity for each sequentially successive frames. Similarly, in row inversion operation mode, display elements in adjacent rows are driven with opposite polarity display data signals and change polarity for each sequentially successive frame. Dot inversion operation mode employs a combination of the column and row inversion that causes a sub-pixel-by-sub-pixel or display unit (e.g., pixel-by-pixel) inversion. In dot inversion operation mode, the display data signals applied to each sub-pixel or display unit pixel's voltage change polarity according to the one of neighbor pixel's polarity. Rather than employing charge sharing only responsive to an indication of a change of state of the polarity of the display data, the timing controller 104 invokes charge sharing based on the data pattern of the portion of a row of display data applied to one or more channels independent of a change in the polarity period. Accordingly, the disclosed display panel subsystem 100 reduces dynamic power consumed by source drivers 106 independent of the occurrence of a polarity state transition of the display data supplied to the source drivers 106.

The additional control information also includes charge sharing configuration information specify one or more conditions for initiating charge sharing between output channels. The conditions include the state of one or more control signals received or generated by the display data receiver 202 that are used as a basis to determine when charge sharing is initiate, and how to group output channels together during charge sharing operation. For example, in one implementation, the conditions for enabling charge sharing for a particular channel include detecting a change in a portion of a row of display data supplied to the channel during two different time periods. In one implementation, the change in the portion of the row of display data includes a change in the most significant bit of the portion specified output channel. The change occurs during two different time periods as described with reference to FIG. 3. In other implementations, the change in the portion of the row of display data includes changes to bits other than the MSB of the portion over two different time periods. In one implementation, the two different time periods include two consecutive row display data write cycles. In other implementations, the two different time periods include non-consecutive row display data write cycles, or consecutive or non-consecutive time periods other than row display data write cycles. Information describing how the outputs of output channels should be connected during charge sharing includes information describing one or more rules for grouping of output channels during charge sharing. An example rule specifies grouping the outputs of source drivers 106 into one or more groups of odd numbered channels identified for charge sharing and separately grouping odd numbered channels identified for charge sharing into one or more groups.

FIG. 3 shows a table 300 that illustrates data pattern-based charge sharing for output channels of a display panel subsystem 100. The table 300 includes columns labeled channel 302, polarity 304, time period 1 (T1) 306, time period 2 (T2) 308, and charge sharing status 310. The table 300 includes rows 312-326 corresponding to output channels Y1-Y8, respectively. The channel column 302 indicates a particular channel number. The polarity column 304 indicates the polarity state (e.g., positive or negative) of the portion of the row data output by the corresponding channel. For example, channel Y1 has a positive polarity state, while channel Y2 has a negative polarity state. The time period T1 corresponds to the time period during which a row of display data is written to a group of output channels. In one implementation, the time period T1 occurs during a single clock cycle. In another implementation, the time period T1 occurs during multiple clock cycles, where the clock cycle is determined based in part on one or more control signals received from the timing controller 104. The value of the portion of the row of display data written to a particular channel during the time period T1 is listed in time period T1 column 306. For example, as shown in FIG. 3, the value of the portion of the row of display data written to channel Y1 during T1 is represented as multi-bit binary value “10001111,” where the left-most bit position is the most significant bit. Similarly, for a specified output channel, the value of the portion of the row of display data written to channel Y2 during T2 is listed in the time period T2 column 308. The time period T2 represents a time period subsequent to the time period T1. In some implementations, T2 is the time period immediately subsequent to the occurrence of the time period T1. In other implementations, the time period T2 occurs after at least one intervening time period between T1 and T2. The charge sharing status column 310 indicates whether or not charge sharing is presently employed for a particular output channel. For example, in the embodiment shown in FIG. 3, charge sharing is employed for odd channels Y3, Y5, and Y7, and even channels Y2 and Y6. Charge sharing line 328 illustrates that the outputs of the even channels identified for charge sharing are connected together. Similarly, charge sharing line 330 illustrates that outputs of the odd channels identified for charge sharing are connected together during charge sharing.

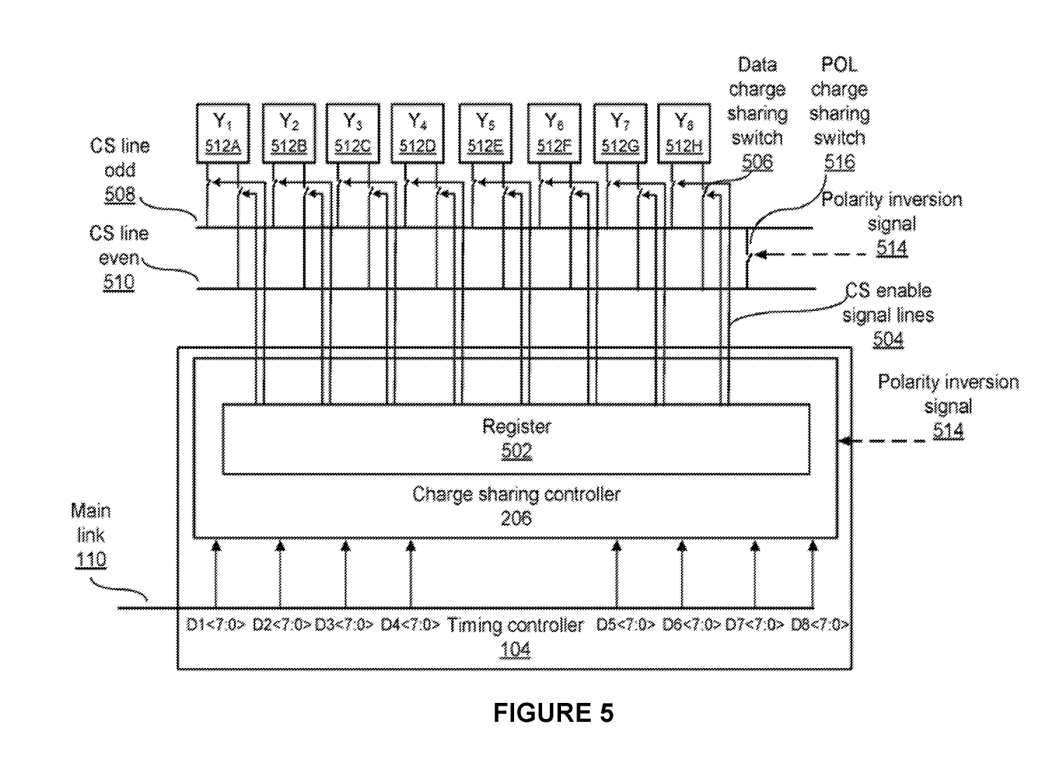

Returning to FIG. 2, the charge sharing controller 206 enables charge sharing among the source drivers 106 of one or more groups of output channels responsive to conditions specified in the charge sharing configuration information. The charge sharing controller 206 obtains charge sharing configuration information from the display data analyzer 204, and generates one or more charge sharing enable signals to connect output channels together within a group of output channels. During charge sharing operation mode, the charge sharing controller 206 generates one or more charge sharing enable signals to control the operation of switches coupled between the outputs the source drivers 106 in accordance with the received charge sharing configuration information. The switches, as further described in reference to FIG. 5, operate to short the outputs of the source drivers 106 together within a specified group, responsive to receiving the charge sharing enable signal. The charge sharing enable signals are generated based on a detected different in the display data written to an output channel over different time periods. Responsive to receiving the charge sharing enable signal, the source driver output circuit 208 generates one or more source driver output disable signals to disable the outputs of the corresponding source drivers 106.

The source driver output circuit 208 transmits to each source driver 106 a portion of the row display data in accordance with the mapping information received by the display data receiver 202. The source driver output circuit 208 also generates one or more control signals to synchronize when each portion of a row of display data is written to each corresponding source driver 106. The source driver output circuit 208 generates one or more additional control signals (e.g., source driver enable) to synchronize when each portion of a row of display data is output by each corresponding source driver 106 output buffer for display on the display panel 116.

To regulate the power consumption of the source drivers 106, the source driver output circuit 208 generates one or more source driver output disable signals. In one implementation, the source driver output circuit 208 generates separate source driver output disable signals to individually disable the output amplifiers coupled to each corresponding output channel. Responsive to the assertion of the source driver output disable signal, the output amplifier within a specified source driver 106 enters a high impedance state. While under a high impedance state, the output amplifier consumes substantially no power. Because the output amplifier consumes the largest portion of power consumed by the source driver 106, when the output amplifiers operate in a high impedance mode the source driver 106 consume substantially no power.

In one implementation, the source driver output circuit 208 generates a source driver output disable signal when the display panel subsystem 100 enters a lower power state. In one example, the source driver output circuit 208 asserts a source driver output disable signal to disable a specified number of source drivers 106 during a vertical blanking period, or during a period of time between frames of display data. The vertical banking period represents time difference between when the last row of one frame is output to the display panel 116, and the beginning of the first row of the next frame. Before the vertical blanking period ends, the source driver output circuit 208 deasserts a source driver output disable signal. Thus, power consumption is reduced while the source driver 106 is disabled. This process is repeated during one or more subsequent vertical blanking period. The source driver output circuit 208 also operates in conjunction with the charge sharing controller 206 to generate one or more source driver output disable signals to disable the outputs of the corresponding source drivers 106 during charge sharing mode.

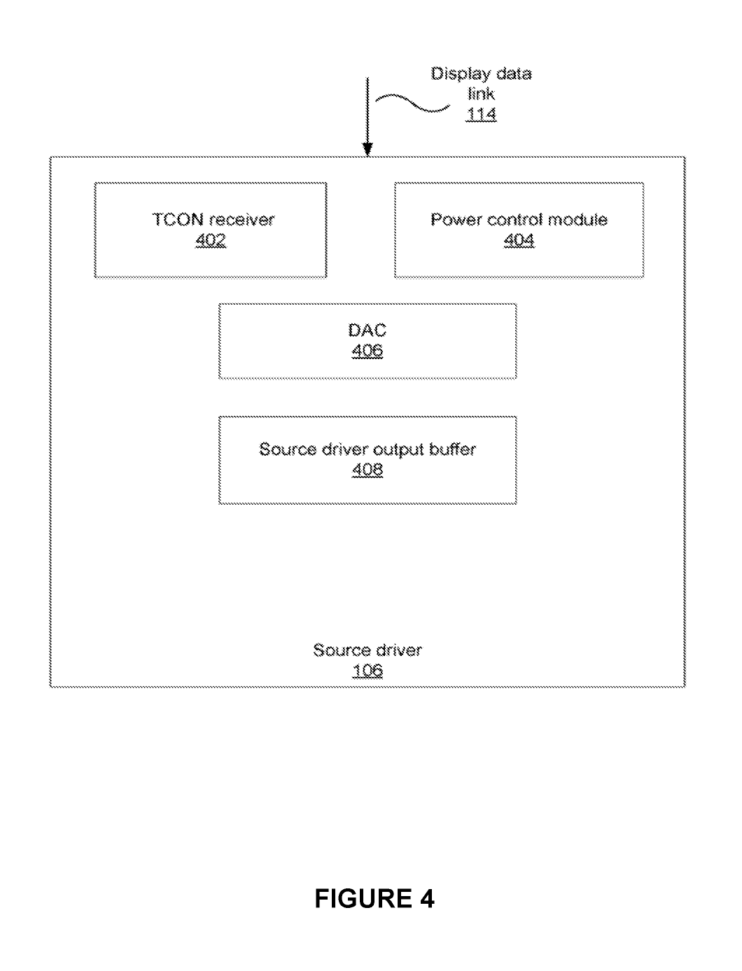

FIG. 4 provides a detailed view of a source driver 106 in accordance with some embodiments. The source driver 106 includes a TCON receiver 402, a power control module 404, a digital-to-analog converter (DAC) 406, and a source driver output buffer 408. The TCON receiver 402 is configured to receive display data from the source driver output circuit 208 included in the timing controller 104.

The power control module 404 controls the power state of a source driver 106 based on instructions received from the timing controller 104. For example, during a vertical blanking period of the video input signal, the timing controller 104 may disable the source driver 106. Disabled, the source driver 106 enters a low power operation mode and ceases to drive the associated display elements coupled to the source driver output buffer 408. The source driver 106 may receive a source driver enable signal from the timing controller 104 and resume a normal operation mode and drive analog voltage signals to the display panel 116.

The DAC 406 processes digital information received by the TCON receiver 402 and converts the digital information to analog signals that will be output by the source driver 106 to drive the display panel 116. The source driver output buffer 408 receives the analog voltage signals from the DAC 406 and buffers and/or amplifies the output of the DAC 406 for operating the active devices associated with sub-pixels within the associated column of the display panel 116.

The source driver output buffer 408 transmits a portion of the row display data to one or more pixels in the corresponding output channel in accordance with the mapping information received by the display data receiver 202. The source driver output buffer 408 also generates one or more control signals to synchronize when each portion of a row of display data is written to each corresponding source driver 106. The source driver output buffer 408 generates one or more additional control signals (e.g., sources driver enable) to synchronize when each portion of a row of display data is output by each corresponding source driver output buffer 408 for display on the display panel 116.

The source driver output buffer 408 also generates one or more source driver output disable signals. In one implementation, the source driver output buffer 408 generates separate source driver output disable signals to individually disable the output amplifiers coupled to each corresponding output channel. When disabled, the output amplifier within a specified source driver 106 enters a high impedance state. In a high impedance state the output amplifier consumes substantially no power. Because the output amplifier consumes the largest portion of power consumed by the source driver 106, when the output amplifier operates in a high impedance state the source driver 106 consumes relatively no power compared to power consumed by the output amplifier under normal operation.

In one implementation, the source driver output buffer 408 generates a source driver output disable signal when the display panel subsystem 100 enters a lower power state. In one example, the source driver output buffer 408 asserts a source driver output disable during a vertical blanking period, or during a period of time between frames of display data. The vertical banking period represents time period between the occurrence of when the last row of one frame is output to the display panel 116, and when the beginning of the first row of the next frame is supplied to the display panel 116. Prior to the vertical blanking period ending and the next frame being transmitted to a source driver 106, the source driver output buffer 408 deasserts a source driver output disable signal. Thus, power consumption is reduced while the source driver 106 is disabled. This process is generally repeated during each vertical blanking period. The source driver output buffer 408 also operates in conjunction with the charge sharing controller 206 to generate one or more sources driver output disable signals to disable the outputs of the corresponding source drivers 106 during charge sharing.

FIG. 5 provides a detailed view of the display panel subsystem 100 in accordance with some embodiments. In the embodiment shown in FIG. 5, the charge sharing controller 206 receives display data over main link 110. During a row display data write cycle, for each output channel, the charge sharing controller 206 stores a multi-bit value, representing a portion of the row of display data associated with the output channel 512, into a portion of the register 502. This process continues until the portion of row of the display data for the last output channel (e.g., 512H) is stored in the register 502. The example of FIG. 5 includes eight output channels Y₁-Y₈, other embodiments may include less or more output channels. The portion of a row of display data associated with the output channels Y1-Y8 is represented as D1<7:0>, D2<7:0>, D3<7:0>, D4<7:0>, D5<7:0>, D6<7:0>, D7<7:0>, and D8<7:0>, where the number following the letter “D” refers to the output channel number, and “<7:0>” refers to an 8-bit value with “bit 7” through and including “bit 0.” In the example shown in FIG. 5, the last bit position is labeled “bit 0” and the first bit position is labeled “bit 7.” In some implementations bit 7 is the MSB and bit 0 is the least significant bit (LSB). In other implementations, bit 0 is the MSB and bit 7 is the LSB. In other implementations, the portion of a row of display data associated with a channel may be less than or more than 8-bits.

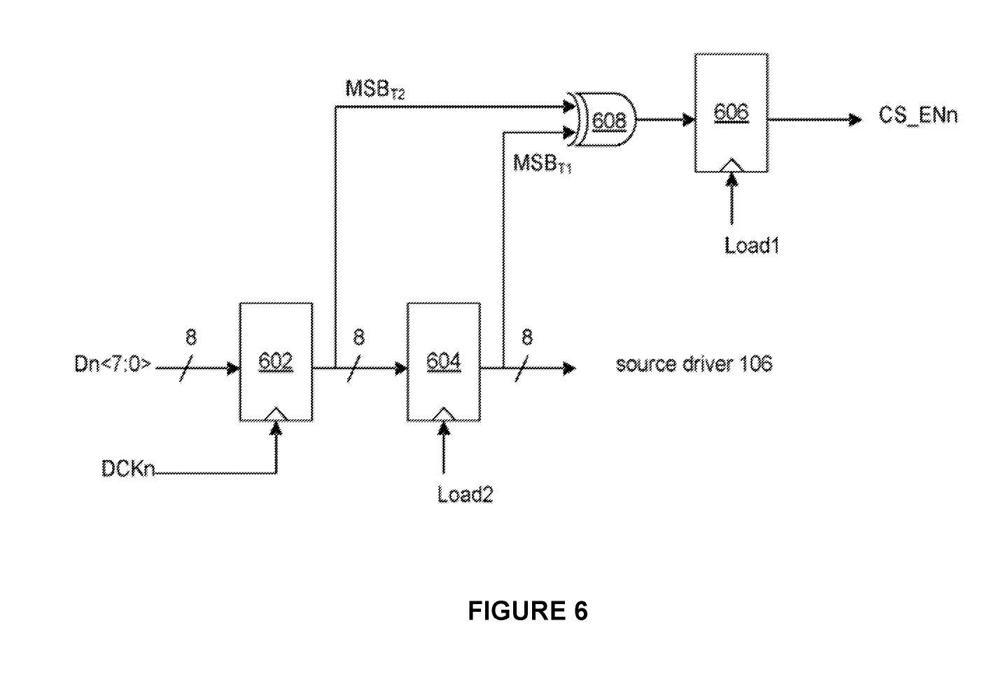

In one implementation, the register 502 is a general purpose storage element with sufficient storage capacity to store multi-bit digital information. The register 502 may be a single storage element, such as a shift register, or multiple storage elements configured to operate together to store and process display data. As previously described, in some implementations, the register 502 is segmented into multiple regions, each region assigned to store display data for a specified output channel. In some implementations, the register 502 includes circuitry to detect the value of a specified bit within a row of display data during a row display data write period, and determine whether the detected value for the same specified bit has changed during a subsequent row display data write period. A circuit diagram of one implementation of row data pattern detection circuitry is further described with reference to FIG. 6.

The register 502 is coupled to each output channel via a pair of charge sharing enable signal lines 504 and a pair of data charge sharing switches 506. Each pair of charge sharing enable signal lines 504 includes an even channel charge sharing line and an odd channel charge sharing line. Each even channel charge sharing line and each odd channel charge sharing line is coupled to a switching terminal of data charge sharing switch 506. As shown in FIG. 5, the data charge sharing switch 506 has a terminal coupled to the output channel 512 and another terminal coupled to either an odd charge sharing line 508 or an even charge sharing line 510. During charge sharing, the charge sharing controller 206 activates the appropriate charge sharing enable signal lines 504 for one or more groups of output channels, as further described with respect to FIG. 6. Once enabled, the charge sharing enable signal lines 504 activate (i.e., close) the associated data charge sharing switches 506 to connect all of the outputs of a group of source drivers to a common charge sharing signal line (i.e., odd charge sharing signal line 508 or even charge sharing signal line 510).

In some implementations, the charge sharing controller 206 also receives the polarity inversion signal 514, which is used to invoke charge sharing among all output channels using POL charge sharing switch 516. In some embodiments, when the polarity inversion signal 514 transitions from a first state to a second state, the POL charge sharing switch 516 closes, causing the outputs of output channels Y₁-Y₈ to be connected to each other. In some implementations, the charge sharing controller 206 uses the polarity inversion signal 514 in combination with disclosed data pattern detection techniques to invoke charge sharing among one or more groups of output channels.

FIG. 6 shows a circuit diagram of display data pattern detection circuitry 600 for an output channel of the display panel subsystem 100 in accordance with some embodiments. In the embodiment shown in FIG. 6, the display data pattern detection circuitry 600 detects a change in a specified bit of a portion of a row of display data for a specified channel stored in an assigned portion of the register 502. Other implementations may be used that include different or additional circuit elements to achieve the same function. The circuit of FIG. 6 includes combinational logic 608 and three latches or flip-flops 602, 604, and 606. In one implementation, the latches and combinational logic are included in the portion of the register 502 corresponding to a particular output channel. Such a configuration is beneficial because no additional line buffer is used to detect a change in a data pattern of the associated row of display data.

The latch 602 receives multi-bit row display data assigned to the respective channel and outputs the received multi-bit data to latch 604 to exclusive OR gate 608. In one implementation, the output of the latch 602 is coupled to the input of the latch 604 using a multiple signal lines. The transmission path between the output of the latch 602 and the input of the latch 604 includes eight transmission lines (i.e., 8-bit parallel bus). In other implementations, alternative bus widths or bus types may be used to exchange data between the latch 602 and the latch 604. The latch 604 receives the multi-bit data from the output of the latch 602 and outputs the received data to the source driver 106. Configured in such a manner, the latches 602 and 604 operate as a shift register to store a portion of the row display data for the output channel during successive time periods. In particular, the latch 604 stores the previous value of a portion of the row of display data at time period T1 responsive to the assertion of the signal DCKn, where n refers to the output channel number. The latch 602 stores the value of the same portion of the row of display data at time period T2, responsive to the assertion of the signal Load2. In the example shown in FIG. 6, the time period T1 occurs before the time period T2.

The latch 602 is also coupled to the exclusive OR gate 608 using at least one signal line or transmission line to provide the specified bit (e.g., the MSB) to the exclusive OR gate 608, which operates as a comparator. One input of the exclusive OR gate 608 is coupled to the output of the latch 602, as previously described. The other input of the exclusive OR gate 608 is coupled to the output of the latch 604 to provide the specified bit (e.g., the MSB) to the exclusive OR gate 608. The exclusive OR gate 608 operates to generate charge sharing enable signal CS_ENn when the specified bit (e.g., MSBT1) generated by the output of the latch 604 is different from the specified bit (e.g., MSBT2) generated by the output of the latch 602. In particular, responsive to receiving the Load1 signal, the exclusive OR gate 608 generates the charge sharing enable signal 504 for the corresponding source driver output amplifier based on whether or not the portion of the display data for an output channel changes in a specified manner between different time periods. The Load1 signal occurs following the transfer of display data into the corresponding latch 602 for each column one by one through shifter register chain 502. The assertion of the signal Load1 occurs before the assertion of the signal Load2. In other words, the data output from the latch 604 is the last row data, which is loaded by Load2, and the data before the Latch2 (i.e., data output from the latch 602) is the current row data. The two MSB's derived from the outputs of latches 602 and 604 are supplied to the exclusive OR gate 608 and latched by Load1 to generated CS_ENn. Responsive to the generation of the CS_EHn signal, the timing controller 104 connects the outputs of even channels identified for charge sharing together and separately connects the output of odd channels identified for charge sharing together. Once connected, the outputs of the even channels within a group are shorted together to cause energy stored in the columns connected to the even channel within the group of channels to be redistributed (i.e., shared). Similarly, once connected, the outputs of the odd channels within a group are shorted together causing energy stored in the columns connected to the odd channel within the group of channels to be redistributed.

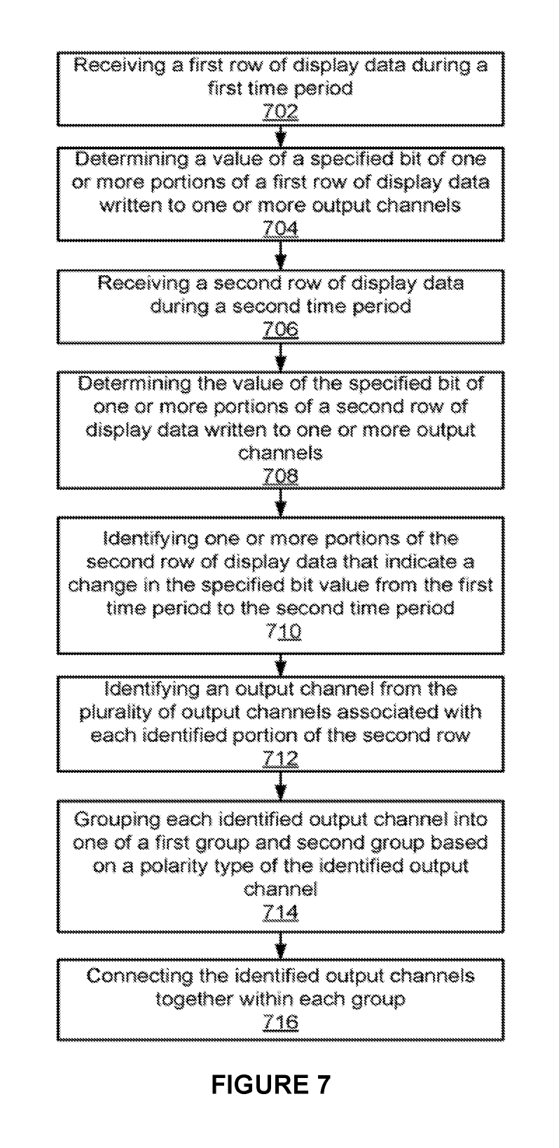

FIG. 7 provides a flow chart describing a method of performing display data-pattern based charge sharing in accordance with some embodiments. The timing controller 104 receives 702 a first row of display data for a first time period. The received display data includes several multi-bit portions, each portion associated with a separate output channel included in a display panel. The display data analyzer 204 determines 704 a value of a specified bit position of portions of the first row of the display data. As previously discussed, the specified bit position may include the most significant bit of the portions of the first row of display data. Display data analyzer 204 may use circuits, such as those shown in FIG. 6, to determine the value of the specified bit within a portion of a row of display data.

The timing controller 104 receives 706 a second row of display data for a second time period. The second row of display data includes several multi-bit portions, each portion associated with a separate output channel included in a display panel. The display data analyzer 204 determines 708 a value of the specified bit position of portions of the second row of display data. The display data analyzer 204 identifies 710 portions of the second row of display data that indicate a change in the specified bit value from the first time period to the second time period. Once identified, the display data analyzer identifies the output channel associated with the identified portions of the second row of display data. The identified output channels represent output channels targeted for charge sharing.

The charge sharing controller 206 arranges the identified output channel into multiple groups based on a polarity type of the identified output channel. In some embodiments, the first group includes identified output channels configured to write positive polarity display data values during the second time period; the second group includes identified output channels configured to write negative polarity display data values during the second time period. In other embodiment, the first and second groups may be switched, or more than two groups of identified output channels may be used. Using the identified groups, the charge sharing controller 206 connects the identified output channels together within each group to allow charge sharing during between the identified output channels.

The data pattern-dependent charge sharing system may be employed independent of a change in the polarity state of the display data, and thus reduces dynamic power consumed by the source drivers 106 during normal operation. Furthermore, integrating the data pattern detection functionality within the timing controller 104 eliminates the need for additional circuitry in the source drivers and enables faster response time to determine which channels to group for charge sharing.

### Additional Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion embodied as executable instructions or code) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and method for performing data-patterned based charge sharing during a polarity period through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope described.

What is claimed is:

1. A method comprising:
receiving a first row of display data for a first time period, the first row of display data comprising a first plurality of multi-bit portions, wherein each multi-bit portion in the first plurality is associated with a separate output channel of a plurality of output channels included in a display panel;
determining a value of a specified bit position for one or more first portions of the first plurality of multi-bit portions in the first row;
receiving a second row of display data for a second time period, the second row of display data comprising a second plurality of multi-bit portions, wherein each multi-bit portion in the second plurality is associated with a separate output channel of the plurality of output channels included in the display panel;
determining a value of the specified bit position for one or more second portions of the second plurality of multi-bit portions in the second row, wherein the one or more second portions correspond to the one or more first portions;
based on the determined values in the first and second rows, identifying one or more of the second portions that indicate a change in the value of the specified bit position from the first time period to the second time period;
identifying an output channel from the plurality of output channels associated with each identified portion of the second row;
grouping each identified output channel into a first group or a second group based on a polarity type of the identified output channel; and
connecting the identified output channels together within each group.

2. The method of claim 1, wherein the first time period is a write cycle for the first row of display data.

3. The method of claim 2, wherein the second time period is a write cycle for the second row of display data.

4. The method of claim 1, wherein the specified bit position is the most significant bit.

5. The method of claim 1, wherein the first group of identified output channels includes even numbered output channels and the second group of identified output channels includes odd numbered output channels.

6. The method of claim 1, wherein the first group of identified output channels includes odd numbered output channels and the second group of identified output channels includes even numbered output channels.

7. The method of claim 1, wherein connecting the identified output channels together within each group comprises connecting the outputs of source drivers coupled to the identified output channels together within the group, responsive to receiving one or more charge sharing enable signals.

8. The method of claim 7, further comprising connecting the identified output channels together within each group during a polarity period.

9. The method of claim 8, wherein the polarity period corresponds to a time period during which a polarity inversion signal remains in the same polarity state.

10. A device comprising:
a display data receiver configured to:
receive a first row of display data for a first time period, the first row of display data comprising a first plurality of multi-bit portions, wherein each multi-bit portion in the first plurality is associated with a separate output channel of a plurality of output channels included in a display panel; and
receive a second row of display data for a second time period, the second row of display data comprising a second plurality of multi-bit portions, wherein each multi-bit portion in the second plurality is associated with a separate output channel of the plurality of output channels included in the display panel;
a display data analysis module configured to:
determine a value of a specified bit position for one or more first portions of the first plurality of multi-bit portions in the first row;
determine a value of the specified bit position for one or more second portions of the second plurality of multi-bit portions in the second row, wherein the one or more second portions correspond to the one or more first portions;
based on the determined values in the first and second rows, identify one or more of the second portions that indicate a change in the value of the specified bit position from the first time period to the second time period;
identify an output channel from the plurality of output channels associated with each identified portion of the second row; and
a charge sharing controller configured to:
group each identified output channel into a first group or a second group based on a polarity type of the identified output channel; and
connect the identified output channels together within each group.

11. The device of claim 10, wherein the first time period is a write cycle for a first row of display data.

12. The device of claim 11, wherein the second time period is a write cycle for a second row of display data.

13. The device of claim 10, wherein the specified bit position is the most significant bit.

14. The device of claim 10, wherein the first group of identified output channels includes even numbered output channels and the second group of identified output channels includes odd numbered output channels.

15. The device of claim 10, wherein the first group of identified output channels includes odd numbered output channels and the second group of identified output channels includes even numbered output channels.

16. The device of claim 10, wherein the charge sharing controller is configured to generate one or more charge sharing enable signals and connect the outputs of source drivers coupled to the identified output channels together within the group using one or more charge sharing enable signals.

17. The device of claim 16, wherein the charge sharing controller is configured to generated one or more charge sharing enable signal signals responsive to identifying an output channel from the plurality of output channels associated with each identified portion of the second row of display data.

18. The device of claim 16, wherein the charge sharing controller is configured connect the identified output channels together within each group during a polarity period.

19. The device of claim 18, wherein the polarity period corresponds to a time period during which a polarity inversion signal remains in the same polarity state.
